(19) United States
(12) Patent Application Publication
(10) Pub. No.: US 2014/0297470 A1
(43) Pub. Date: Oct. 2, 2014

(54) SYSTEMS AND METHODS TO DELIVER GOODS TO A BUYER THAT IS DYNAMICALLY LOCATED

(71) Applicants: David Ramadge, Mountain View, CA (US); Ilya Brown, San Francisco, CA (US); Jack Phillip Abraham, Palo Alto, CA (US); James Palmer, Mammoth Lakes, CA (US); Dean Chen, Easy Haven, CT (US); Shannon B. Vosseller, San Francisco, CA (US)

(72) Inventors: David Ramadge, Mountain View, CA (US); Ilya Brown, San Francisco, CA (US); Jack Phillip Abraham, Palo Alto, CA (US); James Palmer, Mammoth Lakes, CA (US); Dean Chen, Easy Haven, CT (US); Shannon B. Vosseller, San Francisco, CA (US)

(21) Appl. No.: 14/065,264

(22) Filed: Oct. 28, 2013

Related U.S. Application Data
(60) Provisional application No. 61/806,334, filed on Mar. 28, 2013.

(51) Int. Cl. G06Q 30/06

(52) U.S. Cl. CPC G06Q 30/0613; G06Q 30/0635
USPC 705/26.41

(57) ABSTRACT

Systems and methods to deliver goods to a buyer that is dynamically located are described. The system communicates a user interface to a device that is identified as being located at a first location and associated with a customer. The user interface includes items that are identified as being located within a predetermined distance from the device. The system receives an order from the device that authorizes the purchase of an item and delivery of the item to the customer. The system automatically selects a courier from a plurality of couriers that are identified as being located at different locations. The system communicates a user interface to a courier mobile device that includes instructions to enable the courier to retrieve the item from a second location and deliver the item to the first location.

### RELATED APPLICATIONS

This application claims the priority benefit of U.S. Provisional Application No. 61/806,334, filed Mar. 28, 2013 which is incorporated in its entirety by reference.

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright eBay, Inc. 2012, All Rights Reserved.

### TECHNICAL FIELD

This disclosure relates to the technical field of data communications, and more particularly, to systems and methods to deliver goods to a buyer that is dynamically located.

### BRIEF DESCRIPTION OF THE DRAWINGS

Embodiments are illustrated, by way of example and not limitation, in the figures of the accompanying drawings, in which:

FIG. 1 illustrates a system to deliver goods to a buyer that is dynamically located, according to an embodiment;

FIG. 2 further illustrates a system to deliver goods to a buyer that is dynamically located, according to an embodiment;

FIG. 3A is a block diagram illustrating marketplace applications and payment applications, according to an embodiment;

FIG. 3B is a block diagram illustrating dynamic delivery applications, according to an embodiment;

FIG. 3C is a block diagram illustrating a device, according to an embodiment;

FIG. 3D is a block diagram illustrating a mobile device, according to an embodiment;

FIG. 3E is a block diagram illustrating a retail server machine, according to an embodiment;

FIG. 4A is a block diagram illustrating tables, according to an embodiment;

FIG. 4B is a block diagram illustrating mobile delivery information, according to an embodiment;

FIG. 5A is a block diagram illustrating service information, according to an embodiment;

FIG. 5B is a block diagram illustrating area information, according to an embodiment;

FIG. 5C is a block diagram illustrating courier information, according to an embodiment;

FIG. 5D is a block diagram illustrating courier profile, according to an embodiment;

FIG. 5E is a block diagram illustrating courier service information, according to an embodiment;

FIG. 5F is a block diagram illustrating a courier service profile, according to an embodiment;

FIG. 6A is a block diagram illustrating an items table, according to an embodiment;

FIG. 6B is a block diagram illustrating a listing, according to an embodiment;

FIG. 6C is a block diagram illustrating user table, according to an embodiment;

FIG. 6D is a block diagram illustrating user information, according to an embodiment;

FIG. 6E is a block diagram illustrating warehouse information, according to an embodiment;

FIGS. 7A-7F are block diagrams illustrating a method, according to an embodiment, to deliver goods to a buyer that is dynamically located;

FIG. 7G is a block diagram illustrating a method, according to an embodiment, to select a courier;

FIG. 7H is a block diagram illustrating a method, according to an embodiment, to evaluate a courier;

FIG. 7I is a block diagram illustrating a method, according to an embodiment, to generate search results based on the location of items and the location of a device;

FIGS. 8-10 are diagrams of user interfaces, according to an embodiment; and

FIG. 11 shows a diagrammatic representation of a machine in the example form of a computer system, according to an example embodiment.

### DETAILED DESCRIPTION

In the following description, for purposes of explanation, numerous specific details are set forth in order to provide a thorough understanding of some example embodiments. It will be evident, however, to one of ordinary skill in the art that embodiments of the present disclosure may be practiced without these specific details.

### RELATED ART

A user who is shopping may walk into a store to purchase goods and/or services. A user may also purchase goods and/or services over the Internet. Users who shop in brick and mortar stores may also be inclined to simultaneously purchase goods and/or services over the Internet.

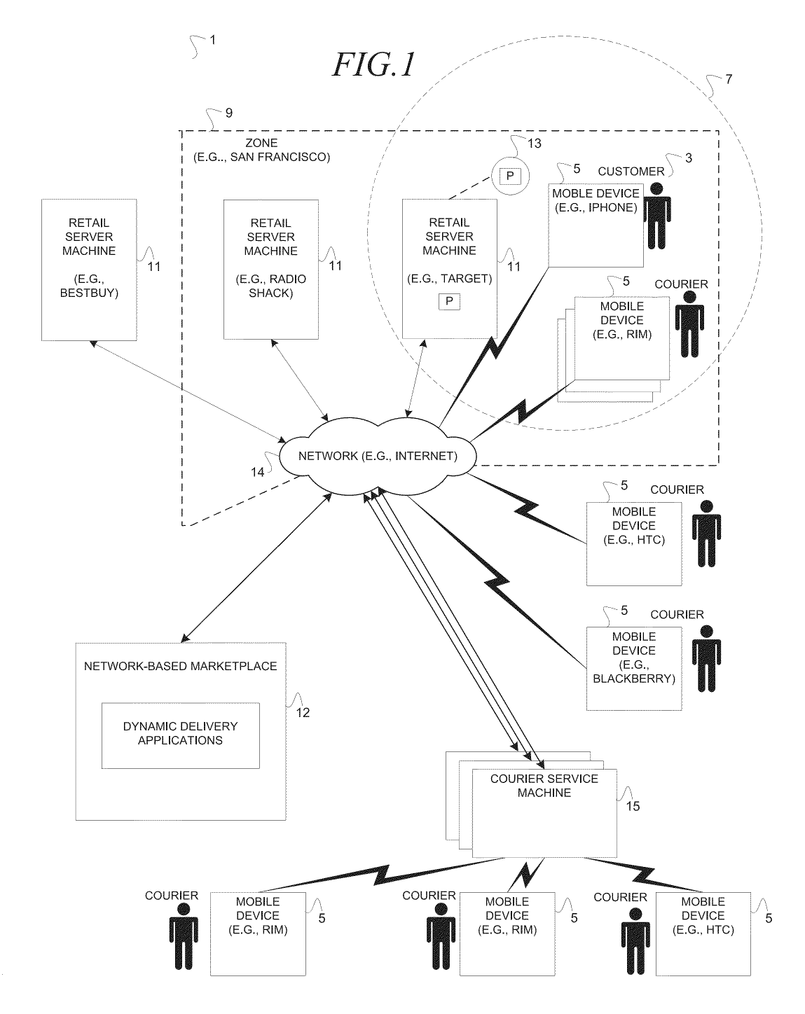

FIG. 1 illustrates a system 1, according to an embodiment, to deliver goods to a buyer that is dynamically located. The system 1 may include a mobile device 5 that is operated by a customer 3 who is moving through the streets of San Francisco. Customer 3 may use the mobile device 5 (e.g., iPhone) to send a query over a network 14 (e.g., cellular telephone network, telephone network, Internet, etc.) to a network-based marketplace 12. The network-based marketplace 12 may include dynamic delivery applications that receive the query, identify the location of the mobile device 5 (e.g., first location), retrieve listings of items that are presently being offered for sale for immediate pick-up from locations that are within a circle 7 and the perimeter of a zone 9 that are determined based on the location of the mobile device 5, and communicate a user interface including descriptions of the items that were identified back to the mobile device 5. The centre-point of the circle 7 may be determined by the location of the mobile device 5 (e.g., first location). The zone 9 may be a predetermined area that is sometimes determined by a zip code. The listings may describe items that are for sale by retailers who are operating retail server machines 11 that are associated with one or more retail brick and mortar stores (e.g., stores). Accordingly, the circle 7 may move with the mobile device 5, and the overlay of the circle 7 over the zone 9 may be utilized to identify the items that are being offered by the retailers for immediate pick-up from stores operated by the retailers and returned on the user interface to the mobile device 5.

The network-based marketplace 12 may receive an order for purchase and immediate delivery of an item from the mobile device 5 and respond to the order by identifying and selecting a courier who picks-up and delivers the item to the customer 3. The network-based marketplace 12 may select the courier based on the location of the mobile device 5 that is operated by the customer 3 (e.g., first location), the location of the item that is ordered by the customer 3 (e.g., second location) and the location of the mobile device 5 that is operated by the courier (e.g., third location). The network-based marketplace 12 may select the courier based on the best route available to the courier (e.g., a route that enables pick-up and delivery of the item to the customer) including the present traffic on the route and the maximum speed supported by the route. The network-based marketplace 12 may further select the courier based on different locations (e.g., second location) from which an item may be picked-up. For example, the customer may order a product from a retailer (e.g., Target) that is available for pick-up as an item from multiple locations within the zone 9 and the circle 7. For example, FIG. 1 illustrates a retailer (e.g., Target) who offers a product for immediate pick-up at a store that is associated with a retail server machine 11 and at a store that is associated with an alternate location 13. Accordingly, the network-based marketplace 12 may select a courier based on the location of the item being picked-up at alternate location 13 to minimize the delivery time of the item. The network-based marketplace 12 may further select a courier service that operates a courier service machine 15 that, in turn, selects a courier who is operating a mobile device 5. The network-based marketplace 12 may select a courier service based on performance of the courier service, feedback received from customers regarding the performance of the courier service and cost of the courier service as described more fully later in this document. In some embodiments, the network-based marketplace 12 may operate to select a courier, select a courier service that selects a courier, or both. The mobile device 5 may be embodied as an iPhone mobile phone manufactured by Apple, Inc. of Cupertino, Calif. or, as, a Blackberry™ mobile phone manufactured by Research In Motion of Waterloo, Ontario. In some embodiments, the customer 3 may operate a stationary device such as a desktop computer (e.g., personal computer).

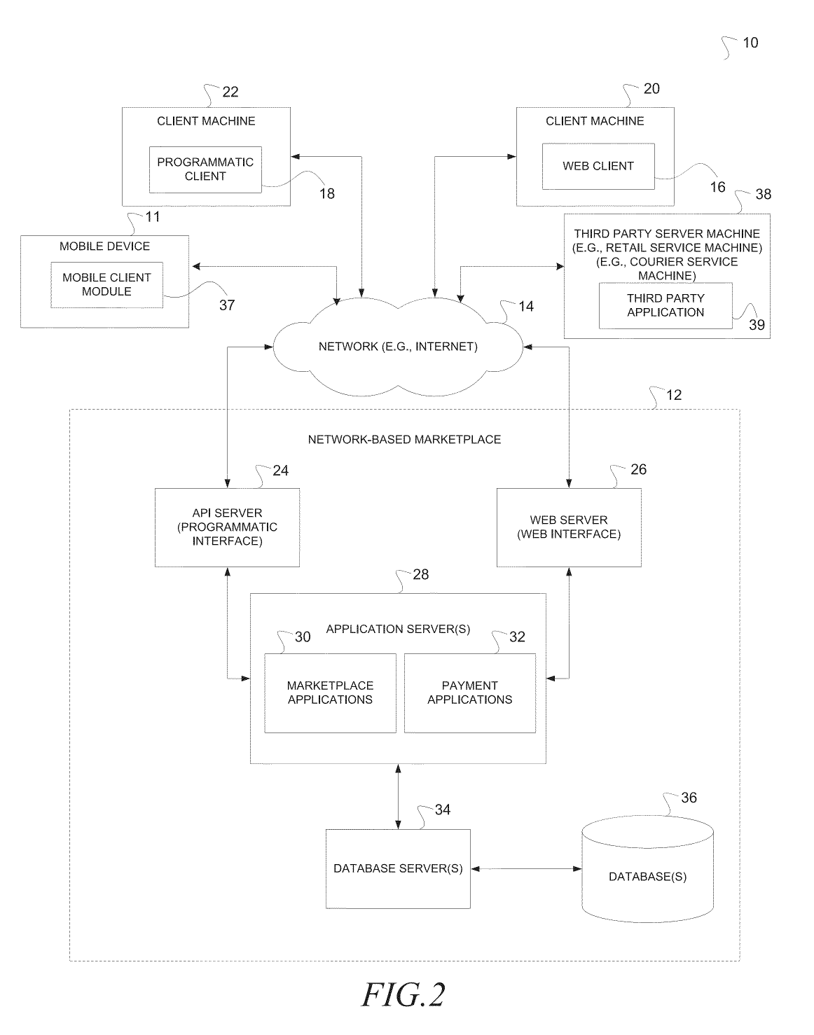

FIG. 2 further illustrates a networked system 10, according to an embodiment, to deliver goods to a buyer that is dynamically located. The networked system 10 corresponds to the system 1 in FIG. 1 and, accordingly, the same or similar references have been used to indicate the same or similar features unless otherwise indicated. The network-based marketplace 12 provides server-side functionality, via a network 14 (e.g., the Internet or Wide Area Network (WAN)) to one or more clients. FIG. 2 illustrates, for example, a web client 16 (e.g., a browser, such as the Internet Explorer browser developed by Microsoft Corporation of Redmond, Wash. State) executing on client machine 20, a programmatic client 18 executing on client machine 22, and mobile client module 37 executing on mobile device 5. For example, the mobile client module 37 may be embodied as one or more mobile modules that are used to support the Blackberry™ wireless hand held business or smart phone manufactured by Research In Motion of Waterloo, Ontario.

An Application Program Interface (API) server 24 and a web server 26 are coupled to, and provide programmatic and web interfaces respectively to, one or more application servers 28. The application servers 28 host one or more marketplace applications 30 and payment applications 32. The application servers 28 are, in turn, shown to be coupled to one or more database servers 34 that facilitate access to one or more databases 36.

The marketplace applications 30 may provide a number of marketplace functions and services to users that access the network-based marketplace 12. The payment applications 32 may likewise provide a number of payment services and functions to users. The payment applications 32 may allow users to accumulate value in accounts and then to later redeem the accumulated value for products (e.g., goods or services) that are made available via, the marketplace applications 30. The value may be accumulated in a commercial currency, such as the U.S. dollar, or a proprietary currency, such as “points.” While the marketplace applications 30 and payment applications 32 are shown in FIG. 2 to both form part of the network-based marketplace 12, it will be appreciated that, in alternative embodiments, the payment applications 32 may form part of a payment service that is separate and distinct from the network-based marketplace 12.

Further, while the networked system 10 shown in FIG. 2 employs client-server architecture, embodiments of the present disclosure are of course not limited to such an architecture and could equally well find application in a distributed, or peer-to-peer, architecture system, for example. The various marketplace applications 30 and payment applications 32 could also be implemented as standalone software programs, which do not necessarily have networking capabilities.

The web client 16 and mobile web client 45 access the various marketplace applications 30 and payment applications 32 via, the web interface supported by the web server 26. Similarly, the programmatic client 18 accesses the various services and functions provided by the marketplace applications 30 and payment applications 32 via the programmatic interface provided by the API server 24. The programmatic client 18 may, for example, be a seller application (e.g., the TurboLister application developed by eBay Inc., of San Jose, Calif.) to enable sellers to author and manage listings on the network-based marketplace 12 in an off-line manner, and to perform batch-mode communications between the programmatic client 18 and the network-based marketplace 12.

FIG. 2 also illustrates a third party application 39, executing on a third party server machine 38, as having programmatic access to the networked system 10 via the programmatic interface provided by the API server 24. For example, the third party server machine 38 may be embodied as the retail server machine 11 and the courier service machine 15, as previously described. The mobile device 5 may be embodied as a mobile phone, a personal digital assistant (PDA), a cell phone, or any other wireless device. For example, the mobile device 5 may be embodied as an iPhone mobile phone manufactured by Apple, Inc. of Cupertino, Calif. or, as previously mentioned or a Blackberry™ mobile phone manufactured by Research In Motion of Waterloo, Ontario.

### Marketplace and Payment Applications

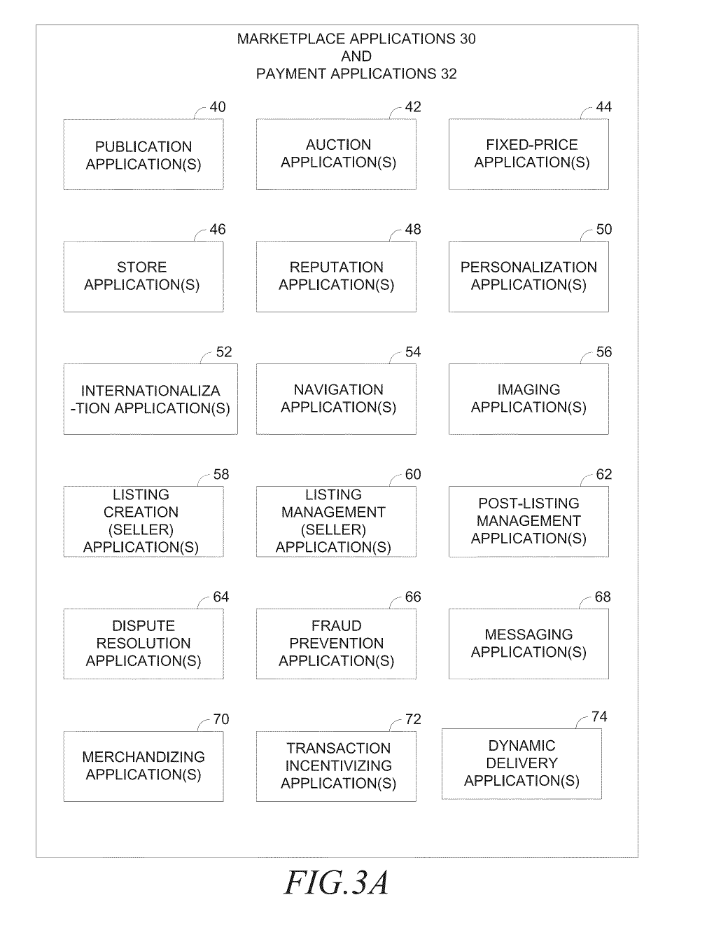

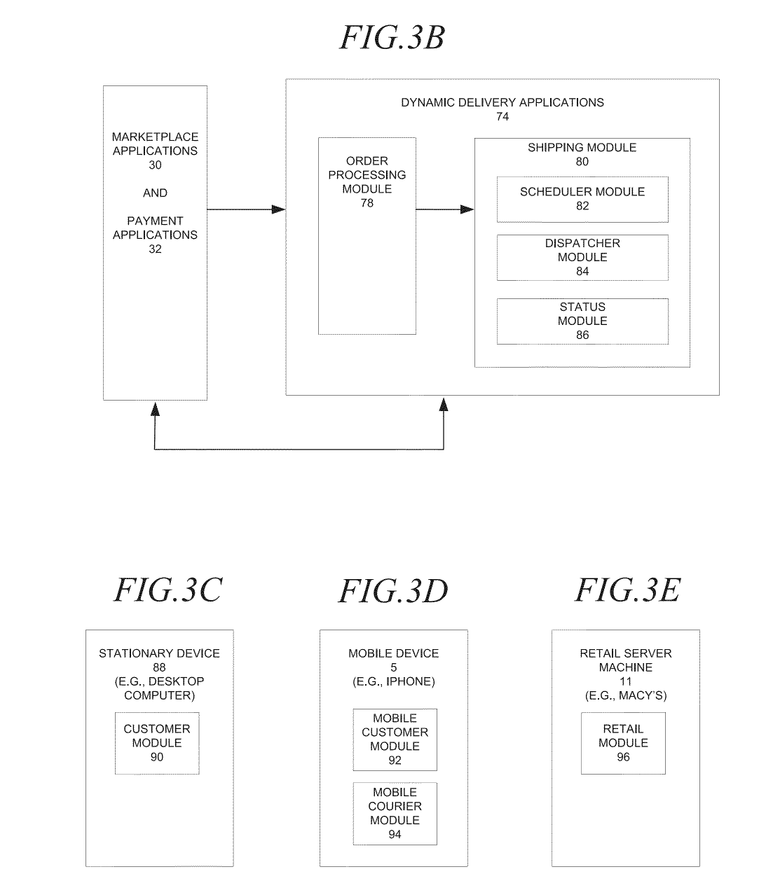

FIG. 3A is a block diagram illustrating marketplace applications 30 and payment applications 32 that, in one example embodiment, are provided as part of the networked system 10 of FIG. 2. The marketplace applications 30 and payment applications 32 may be hosted on dedicated or shared server machines, as shown on FIG. 2, that are communicatively coupled to enable communications between server machines. The applications 30 and 32 themselves are communicatively coupled (e.g., via appropriate interfaces) to each other and to various data sources, so as to allow information to be passed between the applications 30 and 32 or so as to allow the applications 30 and 32 to share and access common data. The applications 30 and 32 may furthermore access one or more databases 36 via the database servers 34, as shown on FIG. 2.

The network-based marketplace 12 of FIG. 2 may provide a number of publishing, listing and price-setting mechanisms whereby a seller may list (or publish information concerning) goods or services for sale; a buyer may indicate a desire to purchase such goods or services; and a price can be set for a transaction pertaining to the goods or services. To this end, the marketplace and payment applications 30 and 32 are shown to include at least one publication application 40 and one or more auction applications 42 which support auction-format listing and price setting mechanisms (e.g., English, Dutch, Vickrey, Chinese, Double, Reverse auctions, etc.). The various auction applications 42 may also provide a number of features in support of such auction-format listings, such as a reserve price feature whereby a seller may specify a reserve price in connection with a listing and a proxy-bidding feature whereby a bidder may invoke automated proxy bidding.

A number of fixed-price applications 44 support fixed-price listing formats (e.g., the traditional classified advertisement-type listing or a catalogue listing) and buyout-type listings. Specifically, buyout-type listings (e.g., including the Buy-It-Now (BIN) technology developed by eBay Inc., of San Jose, Calif.) may be offered in conjunction with auction-format listings and may allow a buyer to purchase goods or services, which are also being offered for sale via an auction, for a fixed-price that is typically higher than the starting price of the auction.

Store application(s) 46 allows a seller to group listings within a “virtual” store, which may be branded and otherwise personalized, by and for the seller. Such a virtual store may also offer promotions, incentives and features that are specific and personalized to a relevant seller.

Reputation applications 48 allow users that transact, utilizing the network-based marketplace 12, to establish, build and maintain reputations, which may be made available and published to potential trading partners. Consider that where, for example, the network-based marketplace 12 supports person-to-person trading, users may otherwise have no history or other reference information whereby the trustworthiness and credibility of potential trading partners may be assessed. The reputation applications 48 allow a user to establish a reputation within the network-based marketplace 12 over time, for example, through feedback provided by other transaction partners and by the computation of a feedback score based on the feedback. For example, the feedback score may be publicly displayed by the network-based marketplace 12. Other potential trading partners may then reference such a feedback score for the purposes of assessing credibility and trustworthiness.

Personalization applications 50 allow users of the network-based marketplace 12 to personalize various aspects of their interactions with the network-based marketplace 12. For example, a user may, utilizing an appropriate personalization application 50, create a personalized reference page at which information regarding transactions to which the user is (or has been) a party may be viewed. Further, a personalization application 50 may enable a user to personalize listings and other aspects of their interactions with the networked system 10 and other parties.

The networked system 10 may support a number of marketplaces that are customized, for example, for specific geographic regions. A version of the networked system 10 may be customized for the United Kingdom, whereas another version of the networked system 10 may be customized for the United States. Some of these versions may operate as an independent marketplace, or may be customized (or internationalized) presentations of a common underlying marketplace. The networked system 10 may accordingly include a number of internationalization applications 52 that customize information (and/or the presentation of information) by the networked system 10 according to predetermined criteria (e.g., geographic, demographic or marketplace criteria). For example, the internationalization applications 52 may be used to support the customization of information for a number of regional websites that are operated by the networked system 10 and that are accessible via respective servers 24 and 26 both of FIG. 2.

Navigation of the network-based marketplace 12 may be facilitated by one or more navigation applications 54. For example, the navigation applications 54 may receive search information (e.g. query) to search for items on the network-based marketplace and process the search information to generate search results. The navigation applications 54 may further include a browse application to enable users to browse various category, catalogue, or inventory data structures according to which listings may be classified within the networked system 10. Various other navigation applications 54 may be provided to supplement the search and browsing applications.

In order to make listings available via the networked system 10 as visually informing and attractive as possible, the marketplace and payment applications 30 and 32 may include one or more imaging applications 56 with which users may upload images (e.g., thumbnail images) for inclusion within listings. An imaging application 56 also operates to incorporate images (e.g., thumbnail images) within viewed listings. The imaging applications 56 may also support one or more promotional features, such as image galleries that are presented to potential buyers. For example, sellers may pay an additional fee to have an image included within a gallery of images for promoted items.

Listing creation applications 58 enable sellers to conveniently author listings pertaining to goods or services that they wish to transact via the network-based marketplace 12, and the listing management applications 60 enable sellers to manage such listings. Specifically, where a particular seller has authored and/or published a large number of listings, the management of such listings may present a challenge. The listing creation applications 58 may further facilitate a buyer watching specific listings or specific types of listings. The listing management applications 60 provide a number of features (e.g., auto-relisting, inventory level monitors, etc.) to assist the seller in managing such listings.

One or more post-listing management applications 62 may also assist sellers with a number of activities that may typically occur post-listing. For example, upon completion of an auction facilitated by one or more auction applications 42, a seller may wish to leave feedback regarding a particular buyer. To this end, a post-listing management application 62 may provide an interface to one or more reputation applications 48, so as to allow the seller conveniently to provide feedback regarding multiple buyers to the reputation applications 48.

Dispute resolution applications 64 provide mechanisms whereby disputes arising between transacting parties may be resolved. For example, the dispute resolution applications 64 may provide guided procedures whereby the parties are guided through a number of steps in an attempt to settle a dispute. In the event that the dispute cannot be settled via the guided procedures, the dispute may be escalated to a third party mediator or arbitrator.

A number of fraud prevention applications 66 implement fraud detection and prevention mechanisms to reduce the occurrence of fraud within the network-based marketplace 12.

Messaging applications 68 are responsible for the generation and delivery of messages to users of the network-based marketplace 12, with such messages, for example, advising users regarding the status of listings at the network-based marketplace 12 (e.g., providing “outbid” notices to bidders during an auction process or to providing promotional and merchandising information to users). Respective messaging applications 68 may utilize any one of a number of message delivery networks and platforms to deliver messages to users. For example, messaging applications 68 may deliver electronic mail (e-mail), instant message (IM), Short Message Service (SMS), text, facsimile, or voice (e.g., Voice over IP (VoIP)) messages via the wired (e.g., the Internet), Plain Old Telephone Service (POTS), or wireless (e.g., mobile, cellular, WiFi (e.g., IEEE 802.11 technologies including 802.11n, 802.11b, 802.11g, and 802.11a)), Worldwide Interoperability for Microwave Access (e.g., WiMAX-IEEE 802.16) networks.

Merchandising applications 70 support various merchandising functions that are made available to sellers to enable sellers to increase sales via the network-based marketplace 12. The merchandising applications 70 also operate the various merchandising features that may be invoked by sellers and may monitor and track the success of merchandising strategies employed by sellers. In addition, the user may utilize the transaction incentivizing applications 72 to select one or more criterion that may be used to generate a social goodness index that is used to generate a badge. Dynamic delivery applications 74 may facilitate the dynamic delivery of goods to a buyer that is dynamically located.

FIG. 3B is a block diagram illustrating dynamic delivery applications 74 in association with marketplace applications 30 and payment applications 32, according to an embodiment. The dynamic delivery applications 74 may include an order processing module 78 and a shipping module 80 that are communicatively coupled to each other and to the marketplace applications 30 and the payment applications 32. Broadly, an order for dynamic delivery may be received by the marketplace applications 30 and communicated to the order processing module 78 that, in turn, communicates the order to a scheduler module 82 that identifies whether the order is for an immediate or scheduled delivery. The dispatcher module 84 may identify a courier for pick-up of the item from a retail store and delivery of the item to the customer. The status module 86 may identify the status of an order, the status of a customer, or the status of a courier and communicate the updated status in user interfaces.

FIG. 3C is a block diagram illustrating a stationary device 88, according to an embodiment. The stationary device 88 (e.g., device) may be embodied as a desktop computer or some other computing device that typically does not move. The stationary device 88 may include a customer module 90 for receiving and communicating search information and orders to the network-based marketplace 12. The customer module 90 may further be utilized for receiving a user interface including a status of an order and displaying the user interface to the customer.

FIG. 3D is a block diagram illustrating a mobile device 5, according to an embodiment. The mobile device 5 (e.g., customer mobile device, courier mobile device) may be embodied as an iPhone as previously described or some other hand held computing device that is mobile. The mobile device 5 may be operated by a customer, a courier, or both. The mobile device 5 may include a mobile customer module 92 (e.g., an application or App) that may be downloaded to the mobile device 5. The mobile customer module 92 may be used for displaying items that are for sale, receiving orders from the customer and communicating orders to the network-based marketplace 12. The mobile customer module 92 may further be utilized for receiving a user interface including a status of the order and displaying the user interface to the customer.

The mobile device 5 may further include a mobile courier module 94 (e.g., an application or App) that may be downloaded to the mobile device 5. The mobile courier module 94 may be used for receiving an availability status from the courier and communicating the availability status to the network-based marketplace 12. The mobile courier module 94 may further be utilized for receiving a user interface including status delivery instructions from the network-based marketplace 12 and displaying the user interface to the courier.

The mobile device 5 may continuously communicate location information into a cellular network to enable other electronic devices to identify the present location of the mobile device 5. For example, the network-based marketplace 12 may monitor the locations of mobile devices 5 that are associated with customers and couriers.

FIG. 3E is a block diagram illustrating a retail server machine 11, according to an embodiment. The retail server machine 11 may be associated with a retail store (e.g., store) that is selling items on the network-based marketplace 12. The retail server machine 11 may include a retail module 96 that communicates inventory information providing information about the items to the network-based marketplace 12 and receives purchase information from the network-based marketplace 12. For example, the inventory information may include a description of an item, an availability of the item, and an estimated checkout time for the item. The purchase information may identify the item for purchase and immediate pick-up.

### Data Structures

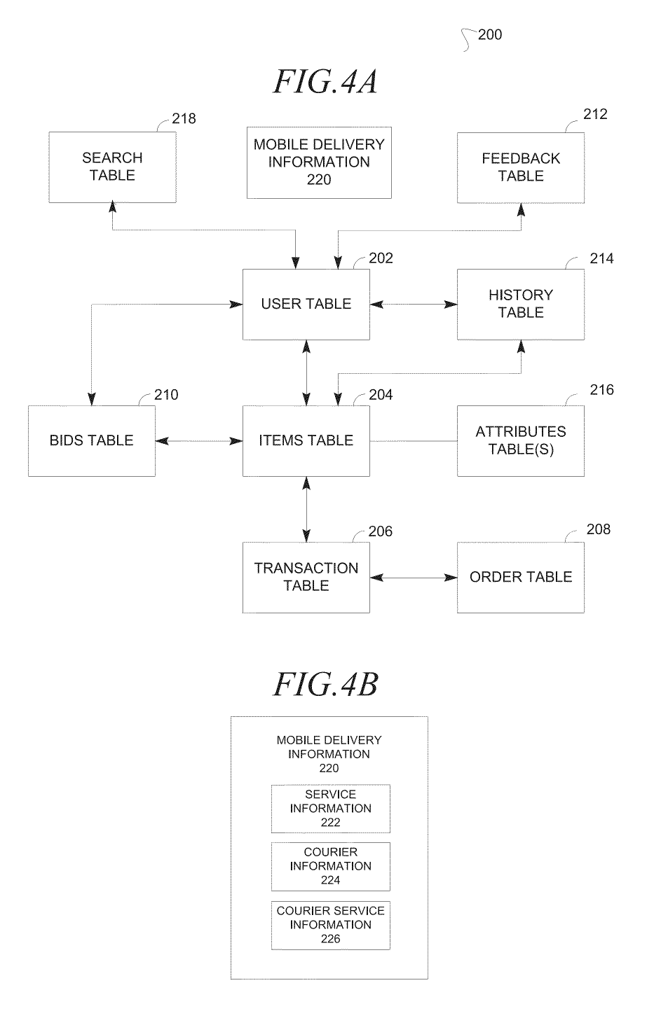

FIG. 4A is a high-level entity-relationship diagram, illustrating various tables 200 that may be maintained within the databases 36 of FIG. 2, and that are utilized by and support the marketplace applications 30 and payment applications 32 both of FIG. 3. A user table 202 may contain a record for each of the registered users of the network-based marketplace 12 of FIG. 2. A user may operate as a seller, a buyer, or both, within the network-based marketplace 12. In one example embodiment, a buyer may be a user that has accumulated value (e.g., commercial or proprietary currency), and is accordingly able to exchange the accumulated value for items that are offered for sale by the network-based marketplace 12.

The tables 200 may also include an items table 204 in which item records (e.g., listings) are maintained for goods and services (e.g., items) that are available to be, or have been, transacted via the network-based marketplace 12. Item records (e.g., listings) within the items table 204 may furthermore be linked to one or more user records within the user table 202, so as to associate a seller and one or more actual or potential buyers with an item record (e.g., listing).

A transaction table 206 may contain a record for each transaction (e.g., a purchase or sale transaction or auction) pertaining to items for which records exist within the items table 204.

An order table 208 may be populated with order records, with each order record being associated with an order. Each order, in turn, may be associated with one or more transactions for which records exist within the transaction table 206.

Bid records within a bids table 210 may relate to a bid received at the network-based marketplace 12 in connection with an auction-format listing supported by an auction application 42 of FIG. 3. A feedback table 212 is utilized by one or more reputation applications 48 of FIG. 3, in one example embodiment, to construct and maintain reputation information concerning users in the form of a feedback score. A history table 214 may maintain a history of transactions to which a user has been a party. One or more attributes tables 216 may record attribute information that pertains to items for which records exist within the items table 204. Considering only a single example of such an attribute, the attributes tables 216 may indicate a currency attribute associated with a particular item, with the currency attribute identifying the currency of a price for the relevant item as specified by a seller. A search table 218 may store search information that has been entered by a user (e.g., buyer) who is looking for a specific type of listing. Mobile delivery information 220 may store information that facilitates delivery of goods/services to a buyer that is dynamically located.

FIG. 4B is a block diagram illustrating mobile delivery information 220, according to an embodiment. The mobile delivery information 220 may include service information 222, courier information 224 and courier service information 226. The service information 222 may describe zones and radius configuration for different areas. The courier information 224 may be used to describe and select couriers. The courier service information. 226 may be used to describe and select courier services.

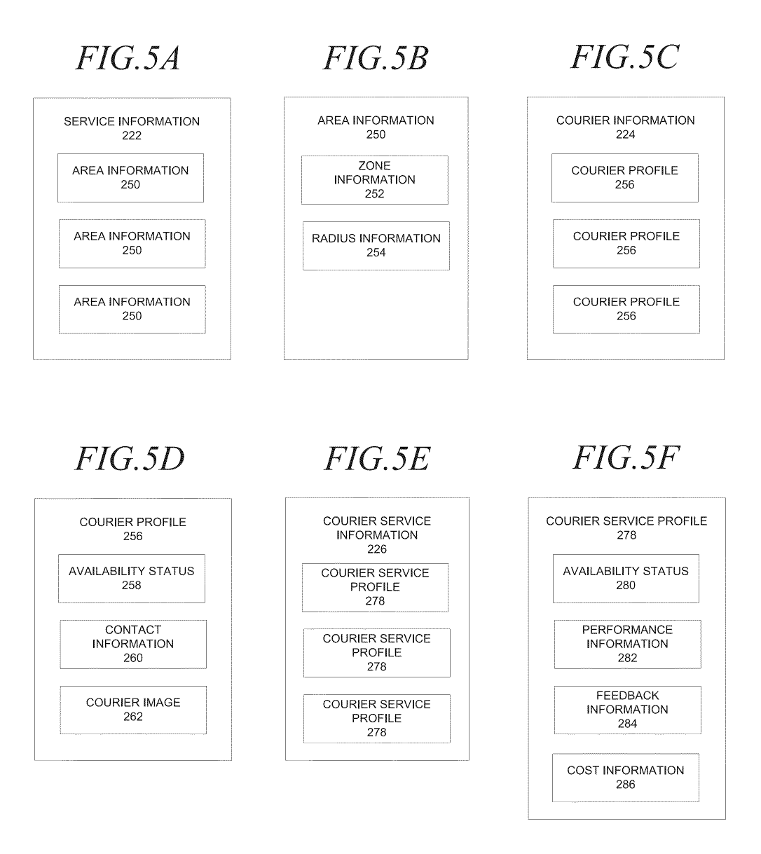

FIG. 5A is a block diagram illustrating service information 222, according to an embodiment. The service information 222 may include multiple entries of area information 250. Each entry of area information 250 may describe a geographic area within which items (e.g., goods or services) may be ordered and delivered.

FIG. 5B is a block diagram illustrating area information 250, according to an embodiment. The area information 250 may include zone information 252 and radius information 254. The zone information 252 may include geographic coordinates that identify the sides of a polygon that connect together to form the perimeter of the zone (e.g., zone 9). In one embodiment a zone may be synonymous with the boundaries of a zip code. The radius information 254 defines the length of a radius associated with a mobile device that is located in the zone. The length of the radius defines a circle that is applied to the current location of a mobile device. The zone (e.g., zone 9) and the circle (e.g., circle 7) may be used to filter search results as previously described. Broadly, a customer who enters a search from a mobile device may be associated with a particular area information 250 entry based on the location of the mobile device at the time of the reception of the search. The customer may be provided with search results that include items that are obtainable only from sources that reside within the associated zone as defined by the zone information 252 and circle as defined by the radius information 254.

FIG. 5C is a block diagram illustrating courier information 224, according to an embodiment. The courier information 224 may include multiple courier profiles 256 where each courier profile 256 may be associated with a courier. The network-based marketplace 12 may use the courier information 224 to select a courier.

FIG. 5D is a block diagram illustrating a courier profile 256, according to an embodiment. The courier profile 256 may include an availability status 258, contact information 260, and a courier image 262. The availability status 258 may indicate that status of a courier. For example, the courier may set their status to “available” or “not available.” The contact information 260 may include information that is used to contact the courier. For example, the contact information 260 may include a telephone number of a mobile device 5 that is operated by a courier or a home telephone number of a courier. The courier image 262 may include a picture or illustration of the courier.

FIG. 5E is a block diagram illustrating a courier service information 226, according to an embodiment. The courier service information 226 may include multiple courier service profiles 278 where each courier service profile 278 may be associated with a courier service. The network-based marketplace 12 may use the courier service information 226 to select a courier service that, in turn, selects a courier.

FIG. 5F is a block diagram illustrating a courier service profile 278, according to an embodiment. The courier service profile 278 may include an availability status 280, performance information 282, feedback information 284 and cost information 286. The availability status 280 may indicate the status of a courier service. For example, a courier service may communicate a status of “available” or “not available” to the network-based marketplace 12. The performance information 282 may indicate a quality of performance of the courier service. For example, the performance information 282 may include statistics (e.g., average delivery time in association with a distance, longest delivery time, shortest delivery time, etc.). The performance information 282 may enable the comparison of one courier service with another. For example, a first courier service may be associated with a lower average delivery time for a particular distance than a second courier service and thereby receive a higher performance rating. The feedback information 284 may include feedback that is received from customers that have been serviced by the courier service. For example, the feedback information 284 may include comments and/or numeric ratings. The feedback information 284 may enable the comparison of one courier service with another. For example, a first courier service may be associated with a higher numeric rating than a second courier service and thereby receive a higher feedback rating. The cost information 286 may include the cost of the courier service to make a delivery. The cost information 286 may enable the comparison of one courier service with another. For example, a first courier service may be associated with lower costs than a second courier service and thereby receive a higher cost rating. The performance information 282, feedback information 284 and cost information 286 may be used to select a particular courier service to pick-up and deliver an item.

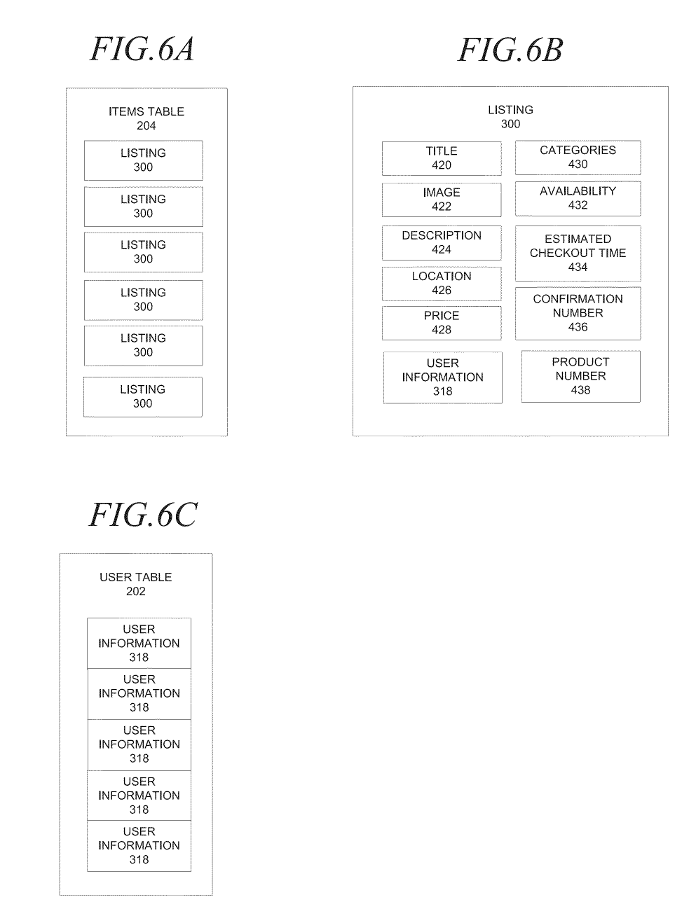

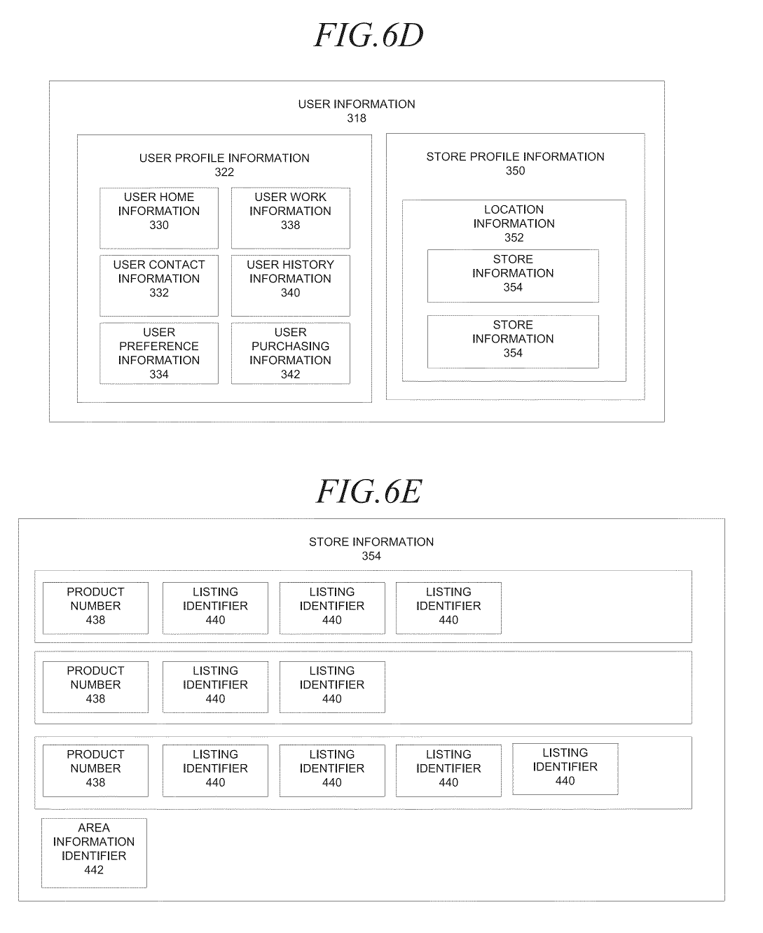

FIG. 6A is a block diagram illustrating an items table 204, according to an embodiment. The items table 204 may include listings 300 that describe items (e.g., goods or services) that are being offered for sale on the network-based marketplace 12.

FIG. 6B is a block diagram illustrating a listing 300, according to an embodiment. The listing 300 may include a title 420, an image 422, a description 424, a location 426, a price 428, categories 430, an availability 432, an estimated checkout time 434, a confirmation number 436, and user information 318. The title 420 may be assigned by the seller (e.g., store) to identify the item. The image 422 provides a visual of the item and the description 424 provides a verbal description of the item. The location 426 describes the location of an item sufficient to enable a courier pick-up the item. For example, the location 426 may include an address of a store. The location 426 may further include a description within a store where a courier may find the item. In some instances the item may be picked-up in an identified department and paid for by the courier. In other instances the item may have been previously purchased by the customer and picked-up from a service that operates within a store. For example, the courier may proceed to a particular location within a store where the item may be waiting for a pick-up by the courier. The price 428 may indicate the cost to purchase the item. The categories 430 may include one or more categories in a category structure that may be browsed on the network-based marketplace 12. The availability 432 may include a count of items immediately available for retrieval. The estimated checkout time 434 may include an estimate of the time that is needed for a courier to enter a store, retrieve the item (e.g., with or without a purchase), and exit the store. For example, the estimated checkout time 434 for a first item (e.g., product A) may be ten minutes at a first retailer (e.g., BestBuy) and fifteen-minutes for a second item (e.g., same product A) at a second retailer (e.g., Radio Shack). The estimated checkout time 434 may be utilized to select a particular retailer from multiple retailers that are offering the same product for sale. The confirmation number 436 may be provided to a courier that, in turn, may provide it to a retailer who verifies the confirmation number 436 as matching to authenticate the courier as commissioned to pick-up the item. The user information 318 may identify the user that is offering the item for sale. The product number 438 may include a unique product identifier (e.g., Universal Product Code (UPC), European Article Number (EAN), Japanese Article Number (JAN), etc.). The product number 438 may identify the item as being a particular instance of a standardized product. The product number 438 may be utilized to find other listings 300 describing items that are instances of the same product that are offered for sale by the same retailer at a different but nearby location, as described further below.

FIG. 6C is a block diagram illustrating a user table 202, according to an embodiment. The user table 202 may include an entry of user information 318 for each user on the network-based marketplace 12. A user may be a buyer, a seller, or both.

FIG. 6D is a block diagram illustrating user information 318, according to an embodiment. The user information 318 may include user profile information 322 and store profile information 350 that is optionally included for a user that is a store. The user profile information 322 may include user home information 330, user contact information 332, user preference information 334, user work information 338, user history information 340 and user purchasing information 342. The user home information 330 may include an address of the home of the user and other information that enables a safe delivery of an item at the home. The user contact information 332 may include telephone numbers, email addresses, and other channels by which the user may be contacted. The user preference information 334 may include preferences of the user. For example, the user preference information 334 may include a nickname of the user. The user work information 338 may describe the user's work environment in order to facilitate an efficient delivery by the courier to a work environment. For example, the user work information 338 may describe a high rise building that requires the courier to be authenticated by a security guard who is posted at a desk located on the first floor of the building. The user history information 340 may include notes describing circumstances associated with previous transactions with the user (e.g., refunds, comments, feedback, etc.). The user purchasing information 342 may describe previous transactions including a description of an item purchased, the price of the item, the date of the transaction, etc. The store profile information 350 may be optionally included for a corporate user (e.g., BestBuy, Radio Shack, etc.). The store profile information 350 (e.g., retailer) (e.g., store) may include location information 352. The location information 352 may include an entry of store information 354 for every store that is associated with the corporate user. The store information 354 may be used to identify other locations of a product that has been ordered by a user to enable the selection of a courier that optimizes the delivery of the item, as described further below.

FIG. 6E is a block diagram illustrating store information 354, according to an embodiment. The store information 354 is associated with a particular brick and mortar store that is located within an area that is identified with an area information identifier 442. The store information 354 may be organized according to a product number 438 that is associated with listing identifiers 440. The listing identifiers 440 point to listings 300 that describe items which are instances of the products that are identified with the product number 438. The store information 354 may enable the selection of courier based on an identification of an item that is closest to a customer.

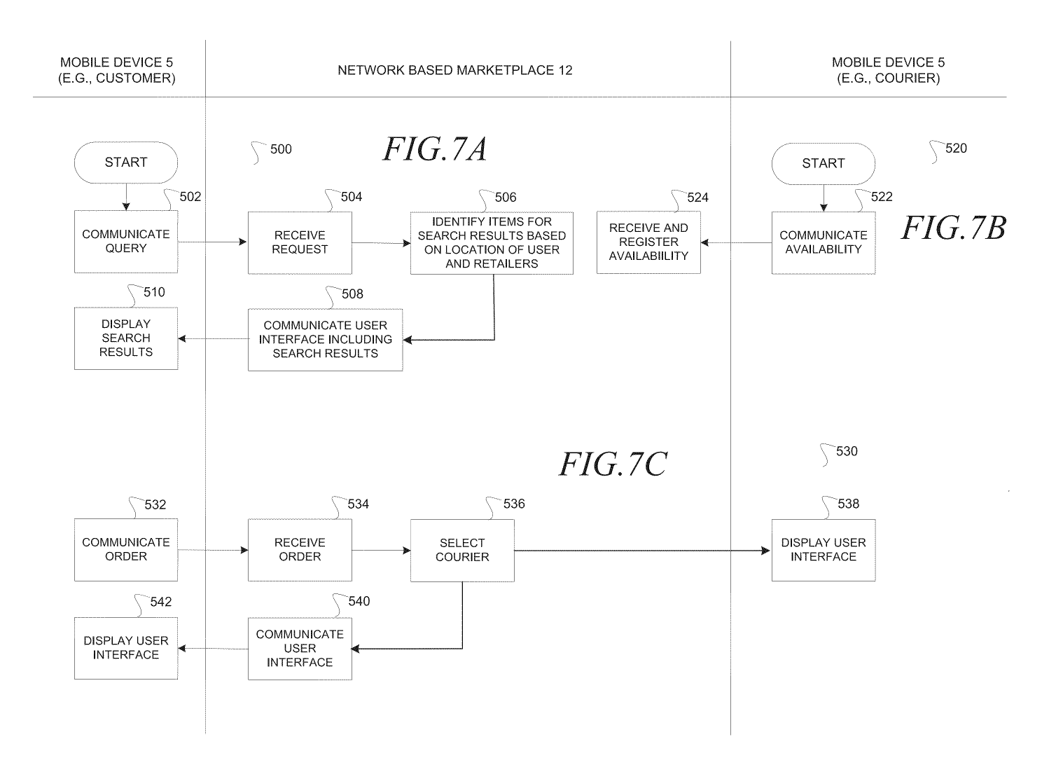

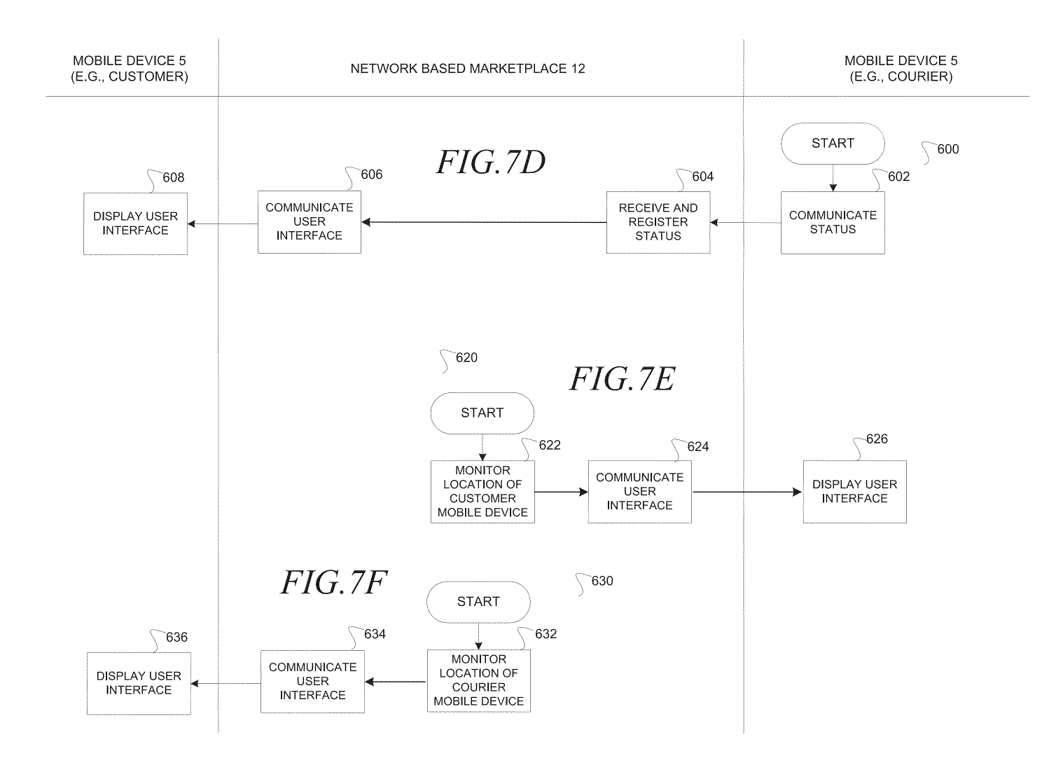

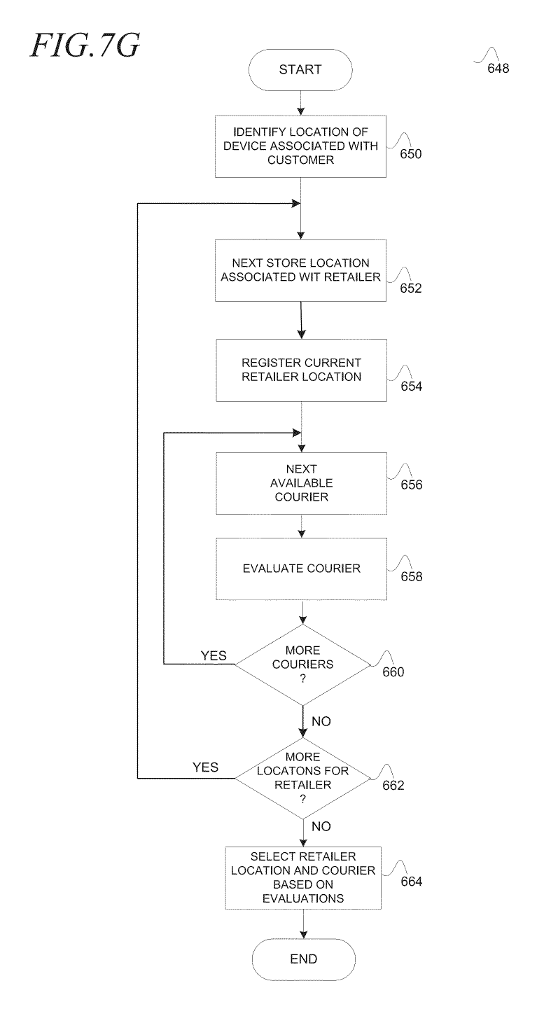

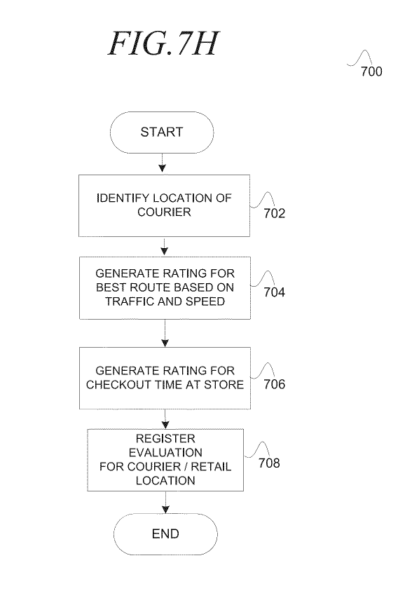

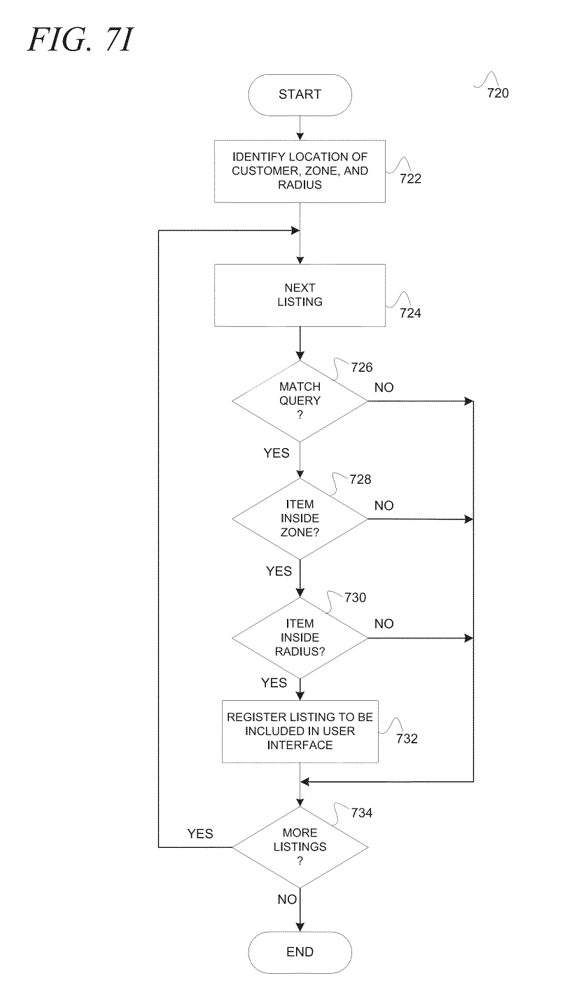

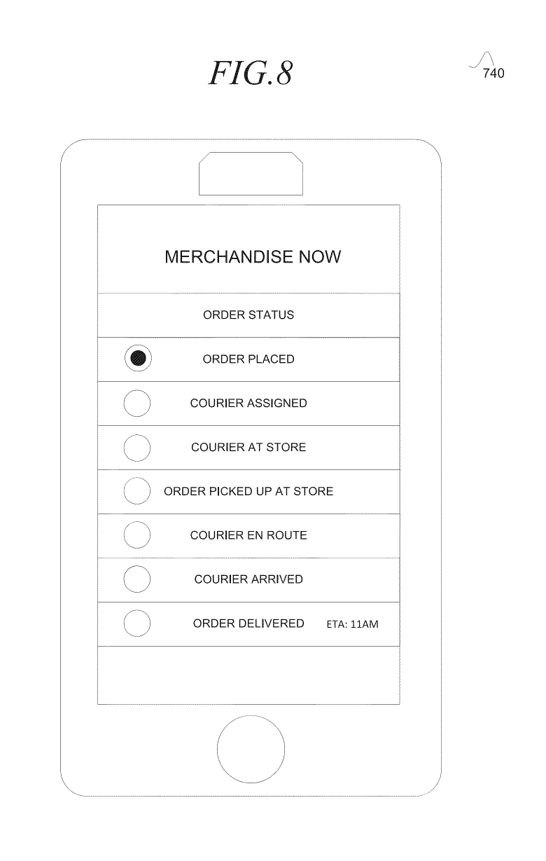

FIGS. 7A-7F are block diagrams illustrating a method, according to an embodiment, to deliver goods to a buyer that is dynamically located. The method includes other methods.

FIG. 7A is a block diagram illustrating a method 500, according to an embodiment, to communicate search results including items located within a radius and zone. The method 500 may commence at operation 502 with mobile device 5 operated by a user (e.g., customer) communicating a search information including a query to the network-based marketplace 12. Other embodiments may include a stationary device 88 (e.g., desktop computer) communicating a query to the network-based marketplace 12.

At operation 504, the navigation applications 54, at the network-based marketplace 12, may receive and process the search information (e.g., query). For example, the network-based marketplace 12 may identify the location of the mobile device 5 based on the search information and the query based on the search information. At operation 506, the navigation applications 54 may identify items to be included in the search results based on the location of the mobile device 5 and the location of the items, as described more fully in FIG. 7I. At operation 508, the navigation applications 54 may communicate a user interface including the search results, including the items located within the radius and the zone, to the mobile device 5. At operation 510, the mobile device 5 may receive the interface and display the search results on the mobile device 5.

FIG. 7B is a block diagram illustrating a method 520, according to an embodiment, to register an availability status. At operation 522, at a mobile device 5 (e.g., iPhone), a courier may communicate an availability status. For example, the courier may utilize the mobile device 5 to communicate a status of “available” or “unavailable.” At operation 524, the network-based marketplace 12 may receive the status, identify the appropriate courier profile 256 based on the courier that sent the status, and register the availability status 258 in the courier profile 256. In like manner the availability status 280 for a courier service may also be registered in the appropriate courier service profile 278.

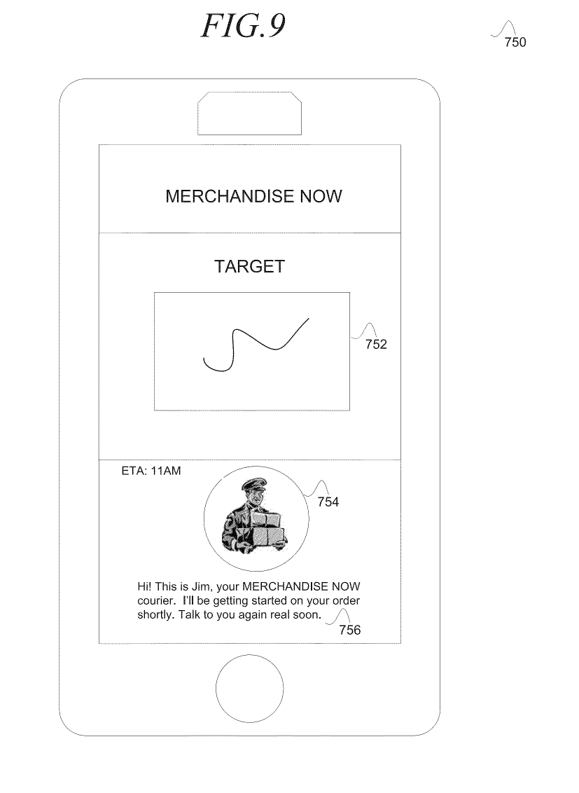

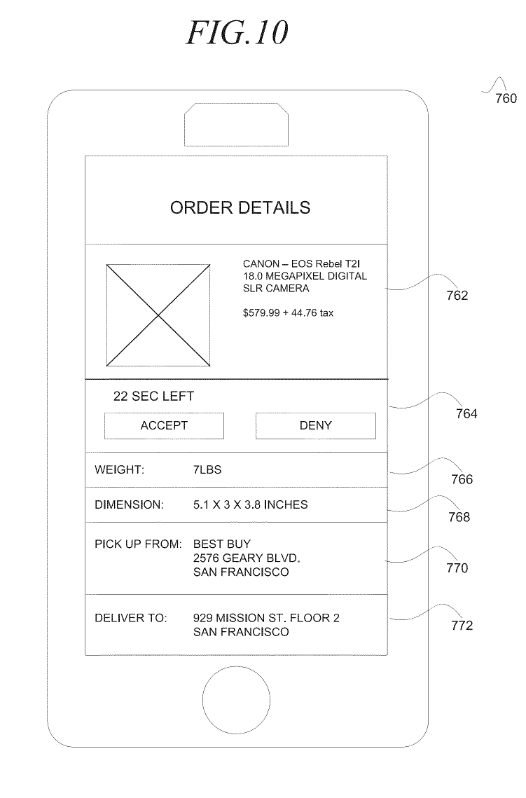

FIG. 7C is a block diagram illustrating a method 530, according to an embodiment, to receive an order. At operation 532, at a mobile device 5 (e.g., iPhone), a customer may use a device to communicate an order for purchase and delivery of an item. At operation 534, at the network-based marketplace 12, the order processing module 78 may receive the order and invoke the shipping module 80 to communicate user interfaces that enable the user to identify whether they would like an immediate or scheduled delivery. Receipt of a request from the customer for an immediate delivery is an instruction to deliver the item as soon as possible. Receipt of a request from the customer for a scheduled delivery is an instruction to deliver the item during a scheduled window of time (e.g., 1 PM to 2 PM; 10:30 AM to 11:30 AM). The location of the delivery may be based on the location of the mobile device 5 at the time of delivery, and the mobile device 5 may be moving at the time of delivery. In another instance, the order may be received from a stationary device 88 and the location of the delivery may be stationary as identified by the customer and described in the user profile information 322 associated with the customer. At operation 536, the shipping module 80 may select a courier based on multiple factors as further described in method 648, as illustrated in FIG. 7G. Further, at operation 536, the shipping module 80 may communicate a user interface to the courier that was selected that requests the courier to accept the task of delivering the item (e.g., FIG. 10). Responsive to receiving a response from the courier indicating a refusal to accept the task, the courier is removed as a candidate for the task and operation 536 is iterated. Responsive to receiving a response from a courier accepting the task, the operation 536 completes. At operation 540, the shipping modules 80 may communicate a user interface to the mobile device 5 that include an image of the courier and an estimated time of arrival (as shown in FIG. 9). At operation 538, the mobile device 5 that is being operated by the courier receives and displays a user that requests the courier to accept the task of delivering the item (e.g., FIG. 10).

In another embodiment the network-based marketplace 12 may select a courier service that operates a courier service machine 15 that, in turn, selects the courier, as described above or in some other manner. The network-based marketplace 12 may select a courier service from courier services that are registered in the courier service information 226 based on the availability status 280, the performance information 282, the feedback information 284 and the cost information 286. For example, ratings may be generated for each of the courier services that are presently available based on ratings of performance, feedback, and cost, and a courier service may be selected based on the highest rating.

FIG. 7D is a block diagram illustrating a method 600, according to an embodiment, to receive and register a courier status. At operation 602, a courier may use a mobile device 5 (e.g., iPhone) to communicate a status to the network-based marketplace 12. For example, the courier may communicate a status to accept the task of retrieving and delivering an item. Also for example, the courier may communicate a status that an item was picked up. Further for example, the courier may communicate a status that they have been unexpectedly delayed. At operation 604, the dynamic delivery applications 74 may receive and register the status. At operation, 606, the dynamic delivery applications 74 may communicate a user interface to the mobile device 5. For example, the user interface may include an image of the courier, an estimated time of arrival and a message from the courier they will be getting started on the order (as shown in FIG. 9). At operation 608, the mobile device 5 that is operated by the customer receives and displays the user interface.

FIG. 7E is a block diagram illustrating a method 620, according to an embodiment, to receive and register a customer location. At operation 622, at the network-based marketplace 12, the dynamic delivery applications 74 may identify the current location of a mobile device 5 (e.g., iPhone) that is being operated by a customer. At operation 624, the dynamic delivery applications 74 may communicate a user interface to the mobile device 5 that is being operated by the courier that indicates the present location of the mobile device 5 that is being operated by the customer. At operation 626, the mobile device 5 that is operated by the courier is displayed.

FIG. 7F is a block diagram illustrating a method 630, according to an embodiment, to receive and register a courier location. At operation 632, at the network-based marketplace 12, the dynamic delivery applications 74 may identify the current location of a mobile device 5 (e.g., iPhone) that is being operated by a courier. At operation 634, the dynamic delivery applications 74 may communicate a user interface to the mobile device 5 that is being operated by the customer that indicates the present location of the mobile device 5 that is being operated by the courier. At operation 636, the user interface is displayed.

FIG. 7G is a block diagram illustrating a method 648, according to an embodiment, to select a courier. The method 648 may begin at operation 650 with the shipping module 80 identifying the location of the stationary device 88 or mobile device 5 from which an item was ordered. At operation 652, the shipping module 80 may identify the next location (e.g., store information 354) of a retailer where the item is being offered for sale. For example, the user may have selected a poncho to be purchased from Target, and the shipping module 80 may utilize the product number 438 in the listing 300 describing the poncho that was selected by the user and the store information 354 to identify whether the poncho is available at any of the other Target locations within the zone and radius associated with the location of the stationary device 88 or mobile device 5 of the user. At operation 654, the shipping module 80 may register the particular location 426 of the retailer that is being evaluated. At operation 656, the shipping module 80 may identify the next available courier. For example, the shipping module 80 may process the next courier profile 256 in the courier information 224 with an availability status 258 that indicates the courier is available. At operation 658, the shipping module 80 may evaluate courier based on multiple factors, as described in FIG. 7H. At decision operation 660, the shipping module 80 may identify whether there are additional couriers to be processed. If additional couriers are to be processed, then processing continues at operation 656. Otherwise processing continues at decision operation 662. At decision operation 662, the shipping module 80 may identify whether additional locations are associated with the retailer. If additional locations are associated with the retailer, then processing continues at operation 652. Otherwise processing continues at operation 664. At operation 664, the shipping module 80 may select the retailer location and the courier based on the evaluations. For example, the shipping module 80 may compare the evaluations to identify the evaluation with the highest numeric value.

FIG. 7H is a block diagram illustrating a method 700, according to an embodiment, to evaluate a courier. The method 700 may commence at operation 702 with the shipping module 80 identifying present location of the mobile device 5 associated with couriers. For example, the shipping module 80 may query a cellular service that provides the coordinates of the mobile device 5 associated with the couriers. At operation 704, the shipping module 80 may identify the best route that starts at the present location of the courier (e.g., third location), pivots at the current retail location of the item (e.g., second location) and connects to the location of the customer (e.g., first location). The best route may be selected based on the least traffic detected on the route and the maximum speed of the route. Finally, the shipping module 80 may generate a rating based on the best route. At operation 706, the shipping module 80 may generate a rating based on the pick-up time associated with the current location of the retailer. For example, the shipping module 80 may utilize the estimated checkout time 434 in the listing 300 of the item to generate a rating. At operation 708, the shipping module 80 may register an evaluation for the courier and the current location of the retailer based on the rating of the best route and the rating of the pickup time. For example, the rating for the best route may be maximized responsive to a prompter delivery service. Also for example, the rating for the pick-up time may be maximized responsive to a quicker pick-up time.

FIG. 7I is a block diagram illustrating a method 720, according to an embodiment, to generate search results based on the location of items and the location of a device. The device may include a stationary device 88 or a mobile device 5. The method 720 may commence at operation 722 with the navigation applications 54 identifying a radius and zone based on the location of a device from which search information (e.g., query) was received. For example, the location of a mobile device 5 may be received with the search information and utilized to identify the appropriate area information 250 entry in the service information 222. The area information 250 may include zone information 252 that includes the perimeter of a zone (e.g., zone 9) and the radius information 254 identifies a radius of a circle 7. At operation 724, the navigation applications 54 identify the next listing 300. At decision operation 726, the navigation applications 54 may identify whether the search information (e.g., query) matches the listing 300. For example, the navigation applications 54 may identify whether keywords in the query match keywords in the title of the listing 300. If the search information does not match the listing 300, then the method proceeds to decision operation 734. If the search information matches the listing, then the method 720 proceeds to decision operation. 728.

At decision operation 728, the navigation applications 54 may identify whether the listing 300 is inside the zone that was previously identified. For example, the navigation applications 54 may compare the location 426 in the listing 300 with the perimeter of the zone to identify whether the location 426 of the listing 300 is inside the perimeter of the zone. If the location of the listing is located inside the zone, then processing continues at decision operation 730. Otherwise processing continues at decision operation 734.

At decision operation 730, the navigation applications 54 identify whether the listing 300 is inside the circle 7 that was previously identified. For example, the navigation applications 54 may compare distance between the location 426 of the item, as identified in the listing 300, and the location of the device (e.g., iPhone), as reported by the device, with the length of the radius of the circle 7 that was previously identified. If the distance between the item and the device (e.g., iPhone) is less than or equal to the length of the radius, then processing continues at operation 732. Otherwise processing continues at decision operation 734.

At operation 732, the navigation applications 54 register the listing 300 to be included in the user interface reporting the search results. At decision operation 734, the navigation applications 54 identify whether additional listings 300 are available. If additional listings 300 are available, then processing continues at operation 722.

FIG. 8 is a diagram of a user interface 740, according to an embodiment, to communicate an order status. The user interface 740 is illustrated as being displayed on a mobile device 5 (e.g., iPhone) and as communicating any one of multiple order statuses. The user interface 740 may include multiple statuses progressing from top to bottom beginning with the order being placed and ending with the order being delivered. The “Order Delivered” status communicates and estimated time of arrival (e.g., ETA). The user interface 740, as illustrated, is communicating a status that an order is being placed.

FIG. 9 is a diagram of a user interface 750, according to an embodiment, to communicate status to a customer. The user interface 750 is illustrated as being displayed on a mobile device 5 (e.g., iPhone) and as communicating an image 752 of the item being delivered, an image 754 of the courier that is delivering the item, and a message 756 from the courier that provides a current status of the order.

FIG. 10 is a diagram of a user interface 760, according to an embodiment, to request a courier to accept a delivery. The user interface 760 may include a product panel 762, a response panel 764, a weight panel 766, a dimension panel 768, a pick-up panel 770, and a delivery panel 772. The product panel 762 may include an image and a description of the product including the cost of the product and the tax associated with the transaction. The response panel 764 may include a decaying timer, an accept response button, and a deny response button. The decaying timer counts down time to expiration. The network-based marketplace 12 may assume the courier denies the offer responsive to the expiration. The weight panel 766 may include the weight of the item, and the dimension panel 768 may include the dimension of the item, both of which may be relevant to a courier on foot with a backpack, a courier riding a bicycle with a bike rack, or some other like constraint. The pick-up panel 770 may communicate the name of the store and the location from which the item is to be retrieved. The delivery panel 772 may communicate the location to which the item is to be delivered. The user interface 760 may be communicated multiple times with an updated delivery panel 772 responsive to the customer changing location.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiples of such hardware-implemented modules exist contemporaneously, communications may be achieved through signal transmission (e.g., over appropriate circuits and buses) that connects the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs))

### Electronic Apparatus and System

Example embodiments may be implemented in digital electro circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of data processing apparatus, e.g. a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture

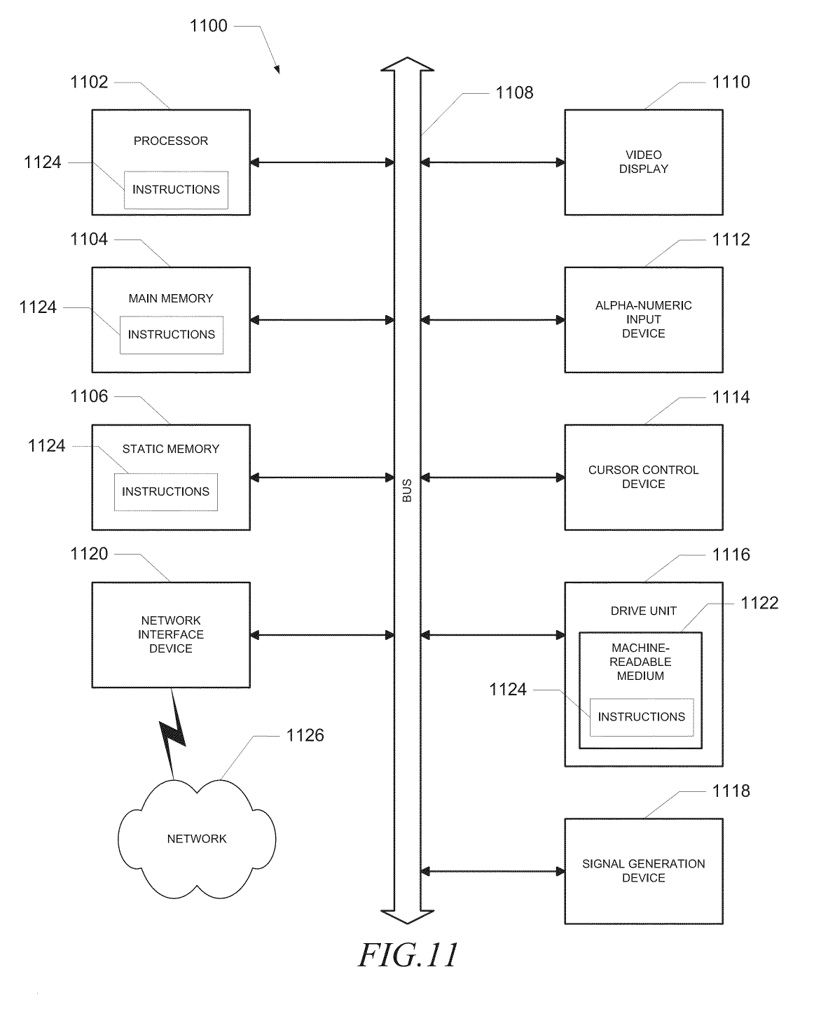

FIG. 11 is a block diagram of a machine within which instructions may be executed for causing the machine to perform any one or more of the methodologies discussed herein. The machine may be embodied as the retail server machine 11, the mobile device 5, the network-based marketplace 12, and the courier service machine 15. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1100 includes a processor 1102 (e.g., a central processing unit (CPU), a graphics processing unit (GPU) or both), a main memory 1104 and a static memory 1106, which communicate with each other via a bus 1108. The computer system 1100 may further include a video display unit 1110 (e.g., a liquid crystal display (LCD) or a cathode ray tube (CRT)). The computer system 1100 also includes an alphanumeric input device 1112 (e.g., a keyboard), a user interface (UI) navigation (e.g., cursor control) device 1114 (e.g., a mouse), a disk drive unit 1116, a signal generation device 1118 (e.g., a speaker) and a network interface device 1120.

### Machine-Readable Medium

The drive unit 1116 includes a machine-readable medium 1122 on which is stored one or more sets of data structures and instructions 1124 (e.g., software) embodying or utilized by any one or more of the methodologies or functions described herein. The instructions 1124 may also reside, completely or at least partially, within the main memory 1104 and/or within the processor 1102 during execution thereof by the computer system 1100, the main memory 1104 and the processor 1102 also constituting machine-readable media. Instructions 1124 may also reside within the static memory 1106.

While the machine-readable medium 1122 is shown in an example embodiment to be a single medium, the term “machine-readable medium” may include a single medium or multiple media (e.g., a centralized or distributed database, and/or associated caches and servers) that store the one or more instructions 1124 or data structures. The term “machine-readable medium” shall also be taken to include any tangible medium that is capable of storing, encoding or carrying instructions for execution by the machine and that cause the machine to perform any one or more of the methodologies of the present inventive subject matter, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 1124 may further be transmitted or received over a communications network 1126 using a transmission medium. The instructions 1124 may be transmitted using the network interface device 1120 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the inventive subject matter. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of ordinary skill in the art upon reviewing the above description. Other embodiments may be utilized and derived therefrom, such that structural and logical substitutions and changes may be made without departing from the scope of this disclosure. The figures provided herein are merely representational and may not be drawn to scale. Certain proportions thereof may be exaggerated, while others may be minimized. Accordingly, the specification and drawings are to be regarded in an illustrative rather than a restrictive sense.

Thus, systems and methods to deliver goods to a buyer that is dynamically located were disclosed. While the present disclosure has been described in terms of several example embodiments, those of ordinary skill in the art will recognize that the present disclosure is not limited to the embodiments described, but may be practiced with modification and alteration within the spirit and scope of the appended claims. The description herein is thus to be regarded as illustrative instead of limiting.

We claim:

1. A system comprising:
at least one processor, and memory including instruction information that, when executed by the at least one processor, cause the system to:
communicate a first user interface to a device that is identified as being located at a first location and associated with a customer, the user interface including a plurality of items that are identified as being located within a predetermined distance from the device, the plurality of items including an item that is located at a second location in a store that is offering the item for sale;
receive an order from the device, the order authorizing the purchase of the item and delivery of the item to the customer, the delivery of the item estimated to be completed within a predetermined period of time from the receipt of the order;
automatically select a courier from a plurality of couriers that are respectively identified as being located at different locations, the courier being associated with a courier mobile device that is identified as located at a third location, the selection of the courier being based on the first location of the device, the second location of the item in the store and the third location of the courier mobile device; and
communicate a second user interface to the courier mobile device, the second user interface including instructions to enable the courier to retrieve the item from the second location and deliver the item to the first location.

2. The system of claim 1, wherein the device includes a customer mobile device and wherein the system communicates a second user interface to the courier mobile device, the second user interface including instructions to enable the courier to deliver the item to a new location associated with the customer mobile device.

3. The system of claim 2, wherein the system communicates a third user interface to the customer mobile device that is located at the first location, the second user interface indicating a particular courier is assigned to retrieve the item that is located at the second location in the store and deliver the item to the customer.

4. The system of claim 3, wherein the third user interface that is communicated to the customer mobile device includes a name of the courier and an estimated time of arrival to deliver the item to the customer.

5. The system of claim 1, wherein the system selects the courier based on a first proximity of the second location to the third location and a second proximity of the second location to the first location.

6. The system of claim 1, wherein the system selects the courier based on a speed associated with a route and traffic associated with the route.

7. The system of claim 1, wherein the system selects the courier based on a checkout time at the store.

8. The system of claim 2, wherein the predetermined distance from the customer mobile device includes a radius for a circle, wherein distance of the radius for the circle is configurable, wherein the center of the circle is the first location.

9. The system of claim 1, wherein the item that is located at the second location in the store is predetermined to be immediately retrievable at the store before being communicated on the user interface that is communicated to the mobile device.

10. A method comprising:
communicating a first user interface to a device that is identified as being located at a first location and associated with a customer, the user interface including a plurality of items that are identified as being located within a predetermined distance from the device, the plurality of items including an item that is located at a second location in a store that is offering the item for sale;
receiving an order from the device, the order authorizing the purchase of the item and delivery of the item to the customer, the delivery of the item estimated to be completed within a predetermined period of time from the receipt of the order;
automatically selecting a courier from a plurality of couriers that are identified as being located at different locations, the courier being associated with a courier mobile device that is identified as located at a third location, the selection of the courier being based on the first location of the device, the second location of the item in the store and the third location of the courier mobile device; and
communicating a second user interface to the courier mobile device, the second user interface including instructions to enable the courier to retrieve the item from the second location and deliver the item to the first location.

11. The method of claim 10, wherein the device includes a customer mobile device and further comprising:
communicating a second user interface to the courier mobile device, the second user interface including instructions to enable the courier to deliver the item to a new location associated with the customer mobile device.

12. The method of claim 11, further comprising:
communicating a third user interface to the customer mobile device that is located at the first location, the second user interface indicating a particular courier is assigned to retrieve the item that is located at the second location in the store and deliver the item to the customer.

13. The method of claim 12, wherein the third user interface that is communicated to the customer mobile device includes a name of the courier and an estimated time of arrival to deliver the item to the customer.

14. The method of claim 10, wherein the selecting the courier from the plurality of couriers that are respectively located at different locations includes selecting the courier based on a first proximity of the second location to the third location and a second proximity of the second location to the first location.

15. The method of claim 10, wherein the selecting the courier from the plurality of couriers that are respectively located at different locations includes selecting the courier based on a speed associated with a route and traffic associated with the route.

16. The method of claim 10, wherein the selecting the courier from the plurality of couriers that are respectively located at different locations includes selecting the courier based on a checkout time at the store.

17. The method of claim 11, wherein the predetermined distance from the customer mobile device includes a radius for a circle, wherein distance of the radius for the circle is configurable, wherein the center of the circle is the first location.

18. The method of claim 10, wherein the item that is located at the second location in the store is predetermined to be immediately retrievable at the store before being communicated on the user interface that is communicated to the mobile device.

19. A machine-readable medium storing instructions that, when executed by at least one processor, cause the at least one processor to perform actions comprising:
communicating a first user interface to a device that is identified as being located at a first location and associated with a customer, the user interface including a plurality of items that are identified as being located within a predetermined distance from the device, the plurality of items including an item that is located at a second location in a store that is offering the item for sale;
receiving an order from the device, the order authorizing the purchase of the item and delivery of the item to the customer, the delivery of the item estimated to be completed within a predetermined period of time from the receipt of the order;
automatically selecting a courier from a plurality of couriers that are identified as being located at different locations, the courier being associated with a courier mobile device that is identified as being located at a third location, the selection of the courier being based on the first location of the device, the second location of the item in the store and the third location of the courier mobile device; and
communicating a second user interface to the courier mobile device, the second user interface including instructions to enable the courier to retrieve the item from the second location and deliver the item to the first location.

20. The machine-readable medium of claim 19, wherein the item that is located at the second location in the store is predetermined to be immediately retrievable at the store before being communicated on the first user interface.
